(19) United States
(12) Patent Application Publication
(10) Pub. No.: US 2014/0343738 A1
(43) Pub. Date: Nov. 20, 2014

(54) POWER GENERATION SYSTEM THAT PREVENTS A GENERATOR FROM SUPPLYING POWER TO A LOAD

(71) Applicant: Kohler Co., Kohler, WI (US)

(72) Inventors: Curtis D. Knight, Milwaukee, WI (US); Andrew John Sember, Plymouth, WI (US); Sean Kenefick, West Dundee, IL (US)

(73) Assignee: Kohler Co., Kohler, WI (US)

(21) Appl. No.: 13/894,656

(22) Filed: May 15, 2013

(51) Int. Cl. G05B 15/02

(52) U.S. Cl. CPC G05B 15/02
USPC 700/287

(57) ABSTRACT

A power generation system includes a generator that includes an alternator and an internal combustion engine configured to drive the alternator to generate power. The power generation system further includes a sensor that detects the presence of a fire condition and a controller that prevents the generator from supplying power when the sensor detects the fire condition.

### TECHNICAL FIELD

This disclosure generally pertains to a power generation system, and more particularly to power generation system that prevents a generator from supplying power to a load.

### BACKGROUND

Electronic devices are increasingly used and relied for performing countless tasks in all areas of life. Many important electronic devices need continuous power to ensure constant and uninterrupted operation.

Often, the power necessary for the operation of electrical equipment is supplied by a primary power source, such as a utility company. However, power from the primary power source may occasionally be interrupted, such as during inclement weather. Additionally, in some instances, an electronic device may require more power than a primary power supplier may typically provide. In still other instances, electronic devices may need to be operated when no primary power source is available (e.g., utility power is lost).

Secondary power sources, such as generators, may be used to satisfy the power needs of electronic devices where primary power is unavailable or insufficient. The secondary power sources may be designed to supply power to the electronic equipment during certain time periods, such as when the primary power source cannot supply the primary power, or when additional power is needed to supplement the power from a primary power source.

### BRIEF DESCRIPTION OF THE DRAWINGS

FIG. 1 is a schematic view illustrating an example power generation system that prevents a generator from supplying power.

FIG. 2 is a schematic view illustrating the example power generation system with a generator controller that selectively operates and protects the generator.

FIG. 3 is a schematic view illustrating another example power generation system that prevents a generator from supplying power.

FIG. 4 is a schematic view illustrating the example power generation system with a generator controller that selectively operates and protects the generator.

FIG. 5 is a schematic view illustrating another example power generation system that prevents a generator from supplying power.

FIG. 6 is a schematic view illustrating an example power generation system that includes a programmable interface module.

### DETAILED DESCRIPTION

The following description and the drawings sufficiently illustrate specific example systems to enable those skilled in the art to practice them. Other example systems may incorporate structural, logical, electrical, process, and other changes. Portions and features of some example systems may be included in, or substituted for, those of other example systems. Example systems set forth in the claims encompass all available equivalents of those claims.

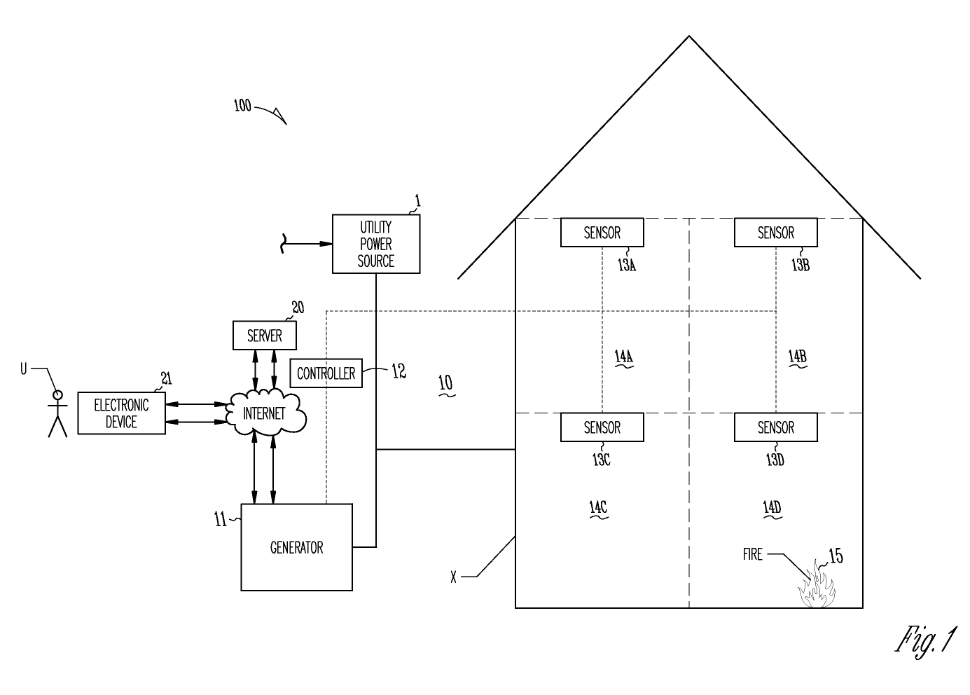

FIG. 1 is a schematic view illustrating an example system 100. A utility power source 1 may provide electrical power to various singular power-consuming entities, such as electrical equipment, aggregate power-consuming locations, such as rooms, homes, building Xs, or other combinations. As an example, the utility power source 1 may provide electrical power to a building X. While the disclosure may refer to a power-consuming entity or location as a building X, it should be appreciated that the systems and methods may also be used with other power-consuming entities, locations, and combinations.

In some instances, the building X may also or alternatively receive electrical power from a secondary power generation system 10. The secondary power generation system 10 may include a generator 11 which may generate electrical power for the building X. The generator 11 may include an engine that produces mechanical energy, and an alternator that may convert the mechanical energy to electrical energy. The generator 11 may provide electrical energy to the building X in various circumstances, such as when the utility power source 1 is not available (such as during inclement weather), when the building X requires more power than the utility power source 1 may provide, or whenever a user determines that it is beneficial to operate the generator 11.

The generator 11 may be located inside or outside of building X. The generator 11 may be located next to, or a distance from, the building X. In some systems, the building X may have multiple generators 11, each of which may be independently connected with one or more loads in the building X, connected together in series, or connected together in parallel. Other variations are possible.

The secondary power generation system 10 may include a controller 12 that controls and/or operates the generator 11. The controller 12 may include a processor, memory, software or firmware, and/or a user interface. The controller 12 may control the operation of the generator 11, such as when to turn on and turn off the generator 11, and when to connect the generator 11 to one or more loads in the building X.

The secondary power generation system 10 may further include one or more sensors 13A, 13B, 13C, 13D that are used to identify the presence of fire or a fire condition. A fire condition may be (i) temperature indicative of fire; (ii) presence of smoke; (iii) presence of a radio signal at a particular frequency; and/or (iv) opening of a switch to cut utility power; or various other conditions or combinations of conditions.

The sensors 13A, 13B, 13C, 13D may, for example, be smoke detectors which may detect smoke within an area of the building X near the sensor 13A, 13B, 13C, 13D. In other examples, the sensors 13A, 13B, 13C, 13D may be temperature sensors that may determine a temperature within the building X that is indicative of the presence of a fire 15 within the building X. In still other examples, the sensors 13A, 13B, 13C, 13D (and/or controller 12) may be electronic frequency detectors that may determine the presence of radio signals at certain frequencies, such as a radio frequency signal used for radio communications by rescue personnel. In these systems, if rescue personnel carry electronic equipment that emits radio frequency signals, then the radio frequency signals may be detected by the sensors 13A, 13B, 13C, 13D and/or controller 12.

Any type of sensor 13 that is known now, or discovered in the future, may be included in the example power generation systems 10 described herein. The type of sensor 13 that is included in the secondary power generation system 10 may depend in part on cost and/or the application where the secondary power generation system 10 will be used. In some systems, one or more of the sensors 13A, 13B, 13C, 13D may be one type of sensor (such as a smoke detector) while others may be another type of sensor (such as a temperature sensor or a frequency detector). Other variations are possible.

The sensors 13A, 13B, 13C, 13D may communicate and exchange data with the controller 12 wirelessly or through a wired connection. For example, the sensors 13A, 13B, 13C, 13D may exchange data with the controller 12 relating to the presence of fire in an environment where the sensors 13A, 13B, 13C, 13D are located. As an example, a sensor 13D may send a signal to the controller 12 when the sensor 13D detects the presence of fire 15. In another example, the sensor 13D may send continuous signals to the controller 12 up to and/or until the sensor 13D detects the presence of a fire 15, after which the sensor 13D may stop sending the continuous signal. Other variations are possible.

The controller 12 may control the operation of the generator 11 based on or in response to communications with the sensors 13A, 13B, 13C, and 13D. For example, the controller 12 may prevent the generator 11 from supplying power when the controller 12 determines that one or more of the sensors 13A, 13B, 13C, 13D detect the presence of fire 15. The controller 12 may prevent the generator 11 from the supplying power to the building X in various ways that are known now, or discovered in the future.

In some forms, the controller 12 may prevent the generator 11 from starting when the one or more of the sensors 13A, 13B, 13C, 13D detect fire 15 within the building X. In other forms, the controller 12 may stop the generator 11 from running when one or more of the sensors 13A, 13B, 13C, 13D detect fire 15 within the building X. In some examples, the generator 11 may continue to operate even though the controller 12 is preventing the generator 11 from supplying power to the building X. In other examples, the controller 12 may ensure that the generator 11 does not run at all.

The sensors 13A, 13B, 13C, 13D may be positioned in various locations in or around the building X. For example, the sensors 13A, 13B, 13C, 13D may be located in different areas (such as different rooms or apartments) 14A, 14B, 14C, 14D within the building X. In other examples, some of the sensors 13A, 13B, 13C, 13D may be located outdoors, or in the same room.

In some systems, one or more sensors 13A, 13B, 13C, 13D may be temperature sensors located near a stove or a furnace, one or more sensors 13A, 13B, 13C, 13D may be a smoke detector located in a room of the building X, and/or one or more sensors 13A, 13B, 13C, 13D may be a frequency detector located at or near the electrical meter outside of the home or near where utility power enters the building X. The arrangement of the sensors within or around the building X may depend on the overall configuration of the building X as well as what is located inside the building X. Other variations and sensor positions are possible.

In some systems where the sensors 13A, 13B, 13C, 13D are positioned in different segmented locations (such as in different building Xs), the controller 12 may prevent the generator 11 from supplying power to the segmented locations where the particular one of the sensors 13A, 13B, 13C, 13D has detected fire, and continue to supply power to the other segmented locations.

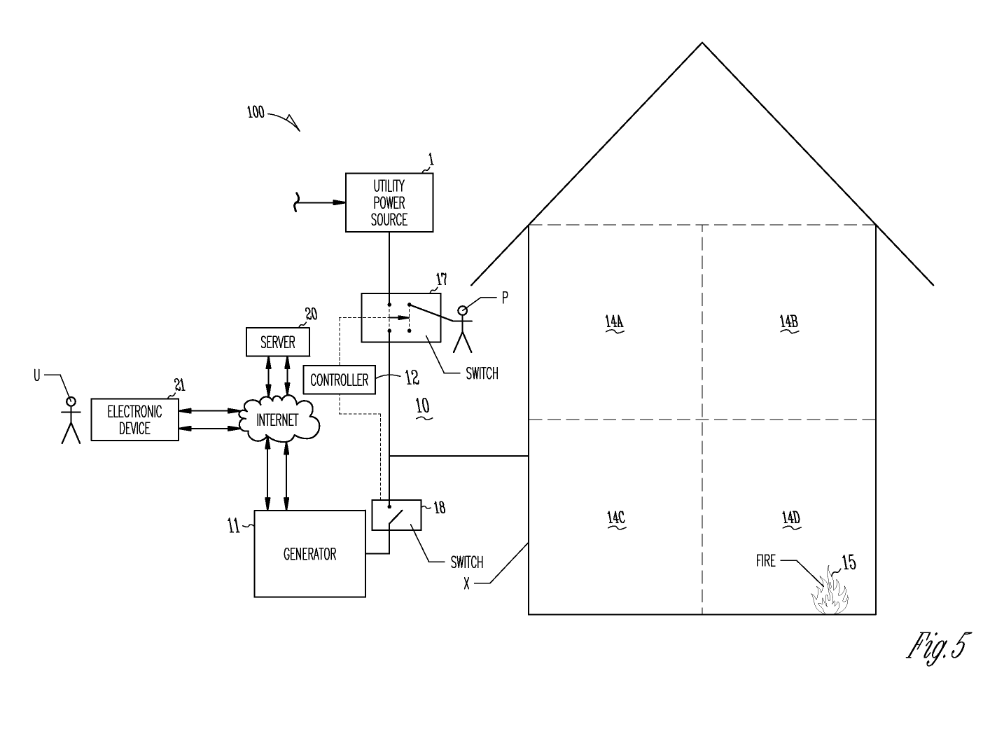

FIG. 5 shows an example form of the power management system 10 where the controller 12 opens a switch 18 that prevents the generator 11 from supplying power to the building X. In other various forms, the controller 12, or some of other type of electronic component, may command some other type of electronic component that is known now, or discovered in the future, to prevent the generator 11 from supplying power to the building X. Other examples are possible.

One example scenario relating to operation of a conventional power generation system is when rescue personnel arrive at the building X when there is fire detected in the building X. Upon arrival, rescue personnel may be trained to cut utility power to the building X (such as by pulling the electrical meter) prior to entering, to avoid inadvertent and undesirable contact with live electricity.

In some power generation systems 10, one of the sensors 13A, 13B, 13C, 13D may detect the presence of the fire 15, as described. Therefore, while a controller in a conventional power generation system might detect the loss of utility power and commands the generator to begin supplying power to the building X creating an unsafe environment for the rescue personnel, the controller 12 in the secondary power generation system 10 may prohibit the generator 11 from providing power to the building X.

In some forms, the controller 12 is configured to receive an override command that allows the generator 11 to supply power to the building X even when one or more of the sensors 13A, 13B, 13C, 13D are detecting fire 15 within the building X. There may be situations where it is desirable to supply power from the generator 11 to the building X even when fire 15 is present within the building X.

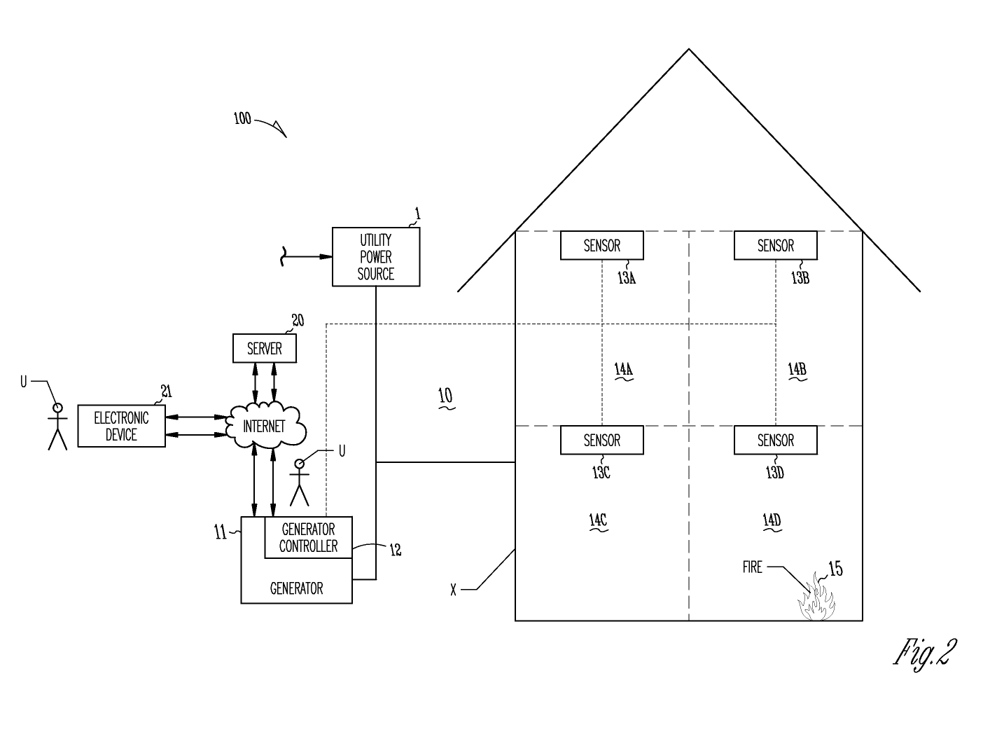

FIG. 2 is a schematic view illustrating the example secondary power generation system 10 shown in FIG. 1 where the controller 12 is a generator controller 12 that selectively operates and protects the generator 11. In some forms, the controller 12 may be included in one or more other components that form the power management system 10, such as for example a transfer switch.

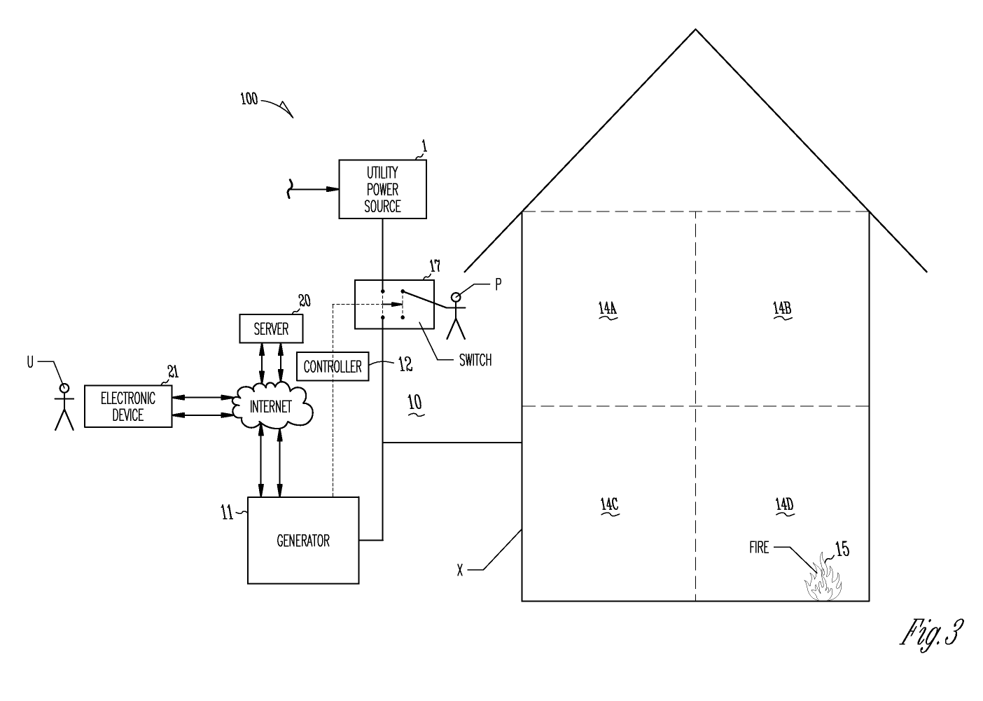

FIG. 3 is a schematic view illustrating another secondary power generation system 10 that may prevent a generator 11 from supplying power to a power-consuming entity such as a building X. The secondary power generation system 10 may include an electrical generator 11 and a controller 12 that operates the generator 11. The electrical generator 11 may include an alternator and an internal combustion engine configured to drive the alternator to generate power.

The controller 12 may communicate with and/or receive data from a switch 17. As an example, the switch 17 may be an electric meter, or a switch connected with an electric meter. In another example, the switch 17 may be a switch which is triggered to move from open to closed (or vice versa) when utility power has been supplied to or cut from a building X.

The switch 17 may be closed when the electric meter is in an active or normal operating position such that utility power is being received by the building X. The switch 17 may be opened when the electric meter is pulled, or is in an inoperative position such that no utility power is being received by the building X. In other systems, the switch may operate in reverse and be open when the electric meter is in a normal operating position, and closed when the electric meter is in the inoperative position.

The controller 12 may control and/or operate the generator 11 based on communications with the switch 17. For example, the controller 12 may detect when the switch 17 has been opened to prevent the building X from receiving primary utility power 1. The controller 12 may prevent the generator 11 from supplying power to the building X when the switch 17 has been opened. In some forms, the generator 11 may continue to operate even though the controller 12 is preventing the generator 11 from supplying power to the building X when the switch 17 has been opened.

As discussed above, the controller 12 may prevent the generator 11 from the supplying power to the building X in various ways that are known now, or discovered in the future. The controller 12 may prevent the generator 11 from starting when the controller 12 detects the switch 17 has been opened. In some forms, the controller 12 may shut down the generator 11 when the controller 12 detects the switch 17 has been opened.

In one example, the switch 17 is an electric meter and the controller 12 prevents operation of the generator 11 when the electric meter has been manipulated by a user U to prevent the building X from receiving utility power from the utility power source 1. One example scenario for opening the switch 17 would be where rescue personnel open the switch 17 when arriving on the scene when fire 15 is detected in the building X.

Another example scenario for opening the switch 17 would be where an electrician pulls the switch 17 to perform maintenance within the building X. When the electrician cuts utility power, a conventional controller may command a generator to begin supplying power to the building X. Therefore, the electrician may undesirably be working in areas of the building X that are now supplied with power by the generator even though the electrician believes power has been cut to the building X. The power management system 10 may prevent individuals from operating in the building X under the misperception that all power has been cut to the building X by preventing the generator 11 from supplying power.

Any type of switch 17 that is known now, or discovered in the future, may be included in the example power generation systems 10 described herein. The type of switch 17 that is included in the secondary power generation system 10 may depend in part on cost and/or the application where the secondary power generation system 10 will be used.

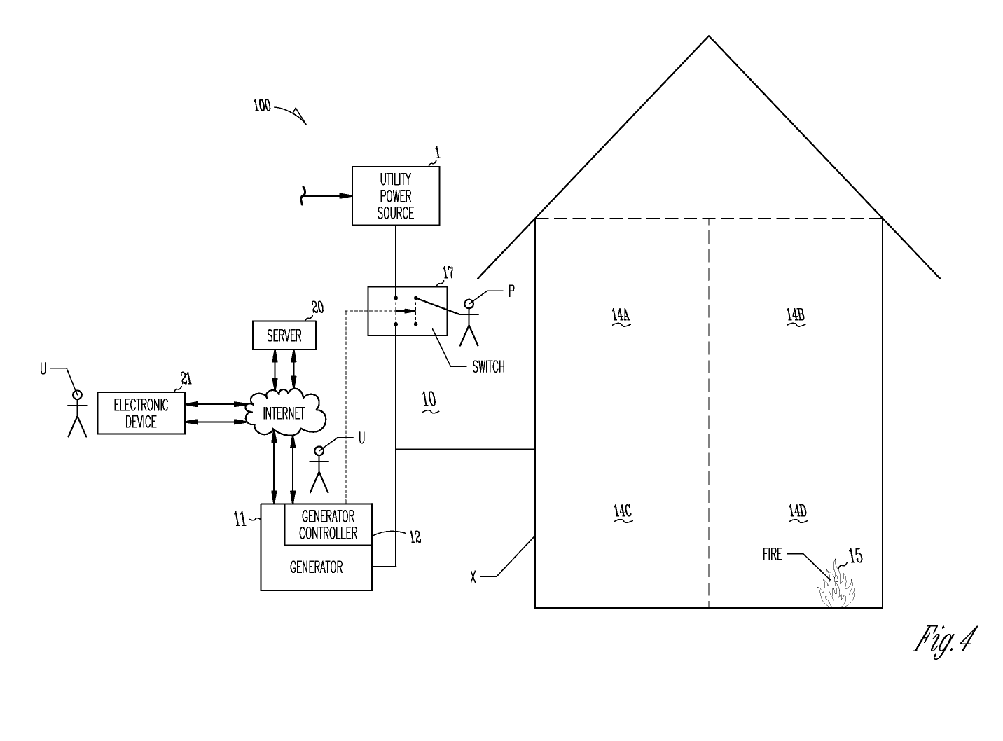

FIG. 4 is a schematic view illustrating the example secondary power generation system 10 shown in FIG. 3 where the controller 12 is a generator controller 12 that selectively operates and protects the generator 11. In some forms, the controller 12 may be included in other components that form the power management system 10.

FIG. 5 shows an example form of the power management system 10 where the controller 12 opens a switch 18 that prevents the generator 11 from supplying power to the building X. In other various forms, the controller 12, or some of other type of electronic component, may command some other type of electronic component that is known now, or discovered in the future, to prevent the generator 11 from supplying power to the building X.

In some forms, the controller 12 may be configured to receive an override command that allows the generator 11 to supply power even when the switch 17 has been opened. There may be situations where it is desirable to supply power from the generator 11 even when the switch 17 is open.

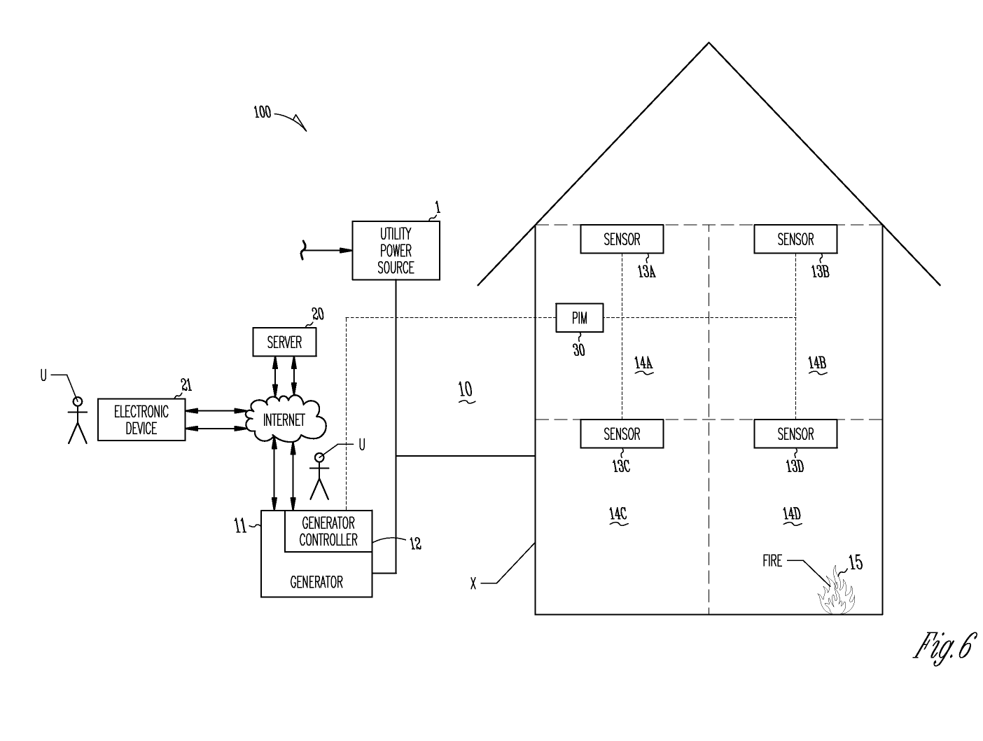

FIG. 6 shows an example secondary power generation system 10 that further includes a programmable interface module 30 that exchanges signals with the sensors 13A, 13B, 13C, 13D and the generator controller 12. In some forms, the programmable interface module 30 includes a sensor circuit (not shown) that converts an input signal received from the sensors 13A, 13B, 13C, 13D for delivery to the generator controller 12.

The programmable interface module 30 exchanges data with the generator controller 12 relating to the presence of fire in an environment where the sensors 13A, 13B, 13C, 13D are located. In some forms, the programmable interface module 30 may be adapted to be located outside or inside the building X to receive signals from the sensors 13A, 13B, 13C, 13D. The programmable interface module 30 may receive signals (i) from the sensors 13A, 13B, 13C, 13D indicating the presence of fire; and/or (ii) indicating that the switch 17 has been opened to prevent the building X from receiving utility power.

In some forms, a particular area of the building X may include multiple programmable interface modules 30. The arrangement of the programmable interface modules 30 within the building X may depend on the overall configuration of the building X as well as what is located inside the building X.

The generator controller 12 may prevent the generator 11 from supplying power when the programmable interface module 30 sends signals to the generator controller. In some forms, the generator 11 may continue to operate even though the programmable interface module 30 is sending signals to the generator controller 12 that indicate the presence of fire within the building X.

It should be noted that the generator controller 12 may include a power source (not shown) that supplies power to operate the programmable interface module 30. As an example, the power source may be a 12V direct current power source, although it should be noted that other sources for powering the programmable interface module 30 are contemplated.

In addition, the power source may be regulated by the generator controller 12. It should be noted that the generator controller 12 may regulate power to the programmable interface module 30 when there is loss of utility power source 1. Therefore, the loss of the utility power 1 may not affect operation of the programmable interface module 30.

In some forms of the power generation systems 10 described herein, the generator 11 and/or generator controller 12 may be configured to provide data relating to operation of the secondary power generation system 10 to a user U via a network. In some forms, the secondary power generation system 10 may further include a server 20 that is connected to the generator 11 and/or generator controller 12 via a network (e.g., the Internet I). It should be noted that the generator 11 and/or the generator controller 12 may be connected to the network in a hard-wired or wireless manner.

The generator 11 and/or generator controller 12 may be configured to exchange data with the server 20. As an example, the server 20 may provide notification to a user U indicating the presence of a fire 15 when the generator 11 and/or generator controller 12 provide data to the server 20 that one of the sensors 13A, 13B, 13C, 13D has detected fire 15. The user U may be able to access the server 20 via any electronic device 21 that is known now or discovered in the future.

In addition, the server 20 may be configured to provide commands from the user U to the generator 11 and/or the generator controller 12 via the server 20 relating to operation of the power management system 10. As an example, the generator 11 and/or the generator controller 12 may be configured to receive commands from the server 20 that override the normal operation of the power management system 10 and permit the generator 11 to supply power.

In some systems, the generator controller 12 may be configured to store data related to the operation of any of the sensors 13A, 13B, 13C, 13D and/or programmable interface module 30 that are included in the secondary power generation system 10. In addition, the generator controller 12 may store and utilize data relating to (i) generator control functions (e.g., start and stop); (ii) load switching functions (e.g., timers to activate the power switching devices); and/or (iii) programmable interface module 30 connections (e.g., inputs and/or outputs to the programmable interface module 30).

In some other example systems, the controller 12 may prevent generator 11 from supplying power to the building X when a combination of conditions are met. For example, the controller 12 may be configured to prevent the generator 11 from providing power to the building X when both a sensor 13A, 13B, 13C, 13D detects the presence of a fire condition and the switch 17 is opened. In this example, in the event of a fire, one or more sensors 13A, 13B, 13C, 13D may provide a signal to the controller 12 of a fire condition. The controller 12 may allow the generator 11 to supply, or continue to supply, power to the building X up to and/or until the switch 17 is opened. Once the switch 17 is opened, the controller 12 may prevent the generator 11 from supplying power to building X. In other examples, the controller 12 may prevent the generator 11 from supplying power to building X based on the signals received from various combinations of sensors 13A, 13B, 13C, 13D and sensor types.

The methods, devices, and logic described above may be implemented in many different ways in many different combinations of hardware, software or both hardware and software. For example, all or parts of the secondary power generation system 10, such as the controller 12, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

The power generation systems 10 described herein may prevent an electric generator 11 from supplying power to a building X when utility power 1 has been lost. Therefore, the power generation systems 10 described herein allow personnel to operate within the building X without unknown power being provided to the building X by the electrical generator 11.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A power generation system comprising:
a generator that includes an alternator and an internal combustion engine configured to drive the alternator to generate power;
a sensor that detects the presence of a fire condition; and
a controller that prevents the generator from supplying power when the sensor detects the fire condition.

2. The power generation system of claim 1, where the generator provides power to a building and the sensor detects the fire condition within the building.

3. The power generation system of claim 2, where the controller prevents the generator from starting when the sensor detects the fire condition within the building.

4. The power generation system of claim 2, where the controller shuts down the generator when the sensor detects the fire condition within the building.

5. The power generation system of claim 2, where the sensor detects smoke within the building.

6. The power generation system of claim 2, where the sensor determines a temperature within the building.

7. The power generation system of claim 2, where the sensor determines a presence of a radio frequency signal.

8. The power generation system of claim 2, wherein the sensor is one a plurality of sensors that are configured to determine the presences of the fire condition within the building, where the controller prevents operation of the generator when any of the plurality of sensors determines the existence of the fire condition within the building.

9. The power generation system of claim 1, wherein the controller is a generator controller that selectively operates and protects the generator.

10. The power generation system of claim 1, wherein the controller is configured to receive an override command that allows the generator to supply power even when the sensor is detecting the fire condition.

11. A power generation system for a building comprising:
a generator that includes an alternator and an internal combustion engine configured to drive the alternator to generate power for the building; and
a controller that operates the generator and determines when a switch has been opened to prevent the building from receiving primary power, where the controller prevents the generator from supplying power to the building when the switch has been opened.

12. The power generation system of claim 11, where the building receives primary power from a utility and the switch is an electric meter such that the controller prevents operation of the generator when the electric meter has been manipulated by a user to prevent the building from receiving power from the utility.

13. The power generation system of claim 11, where the controller prevents the generator from starting when the controller detects the switch has been opened.

14. The power generation system of claim 11, where the controller shuts down the generator when the controller detects the switch has been opened.

15. The power generation system of claim 11, wherein the controller is a generator controller that selectively operates and protects the generator.

16. The power generation system of claim 15, further comprising a server that is connected to the generator controller via a network, wherein the generator controller is configured to exchange data with the server.

17. The power generation system of claim 11, wherein the generator continues to operate even though the controller is preventing the generator from supplying power to the building when the switch has been opened.

18. A power generation system for a building comprising:
a generator that includes an alternator and an internal combustion engine configured to drive the alternator to generate power for the building;
a generator controller that selectively operates and protects the generator and is configured to detect when a switch has been opened to prevent the building from receiving primary power from a utility;
a sensor configured to detect the presence of a fire condition within the building; and
a programmable interface module that sends signals from the sensor and the switch to the generator controller, where the generator controller prevents the generator from supplying power when the sensor determines the existence of the fire condition within the building or the switch has been opened to interrupt utility power to the building.

19. The power generation system of claim 18, where the programmable interface module operates the sensor.

20. The power generation system of claim 18, where the generator controller includes a power source that supplies power to operate the programmable interface module.
